(19) United States
(12) Patent Application Publication
(10) Pub. No.: US 2024/0253645 A1
(43) Pub. Date: Aug. 1, 2024

(54) ABNORMALITY DETECTION SYSTEM AND ABNORMALITY DETECTION METHOD

(71) Applicant: TOYOTA JIDOSHA KABUSHIKI KAISHA, Toyota-shi Aichi-Ken (JP)

(72) Inventors: Yusuke HAYASHI, Atsugi-shi Kanagawa-Ken (JP); Taichi Kawanai, Susono-shi Shizuoka-Ken (JP); Daichi Hotta, Meguro-ku Tokyo-to (JP)

(73) Assignee: TOYOTA JIDOSHA KABUSHIKI KAISHA, Toyota-shi Aichi-Ken (JP)

(21) Appl. No.: 18/532,364

(22) Filed: Dec. 7, 2023

(30) Foreign Application Priority Data
Feb. 1, 2023 (JP) 2023-014244

(51) Int. Cl. B60W 50/02; B60W 40/105; B60W 50/029; B60W 60/00

(52) U.S. Cl. CPC B60W 50/0205; B60W 40/105; B60W 50/029; B60W 60/0015; B60W 2050/021; B60W 2050/0292; B60W 2554/4041; B60W 2554/80

(57) ABSTRACT

An abnormality detection system is applied to an autonomous driving system of a target vehicle. The abnormality detection system stores travel plan information and reference travel information. The travel plan information and the reference travel information indicate a travel plan of the target vehicle and a travel record of a reference vehicle different from the target vehicle, respectively. The abnormality detection system calculates a deviation between the travel plan of the target vehicle and the travel record of the reference vehicle for each determination position based on the travel plan information and the reference travel information. The abnormality detection system extracts the determination position at which the deviation exceeds a threshold as an abnormal position related to an abnormality of the autonomous driving system. The abnormality detection system enables to appropriately detect the abnormality of the autonomous driving system independently of the recognition performance of the autonomous driving system.

### CROSS-REFERENCES TO RELATED APPLICATION

This application claims priority to Japanese Patent Application No. 2023-014244 filed on Feb. 1, 2023, the entire contents of which are incorporated by reference herein.

### TECHNICAL FIELD

The present disclosure relates to an abnormality detection technique applied to an autonomous driving system of a vehicle.

### BACKGROUND ART

Patent Literature 1 discloses an autonomous driving device. The autonomous driving device recognizes traveling environment based on an output signal of a periphery monitoring sensor and makes a control plan based on a result of recognition. In addition, the autonomous driving device determines whether there is an abnormality in the recognition system by continuously monitoring stability of the result of recognition by the periphery monitoring sensor.

### LIST OF RELATED ART

Patent Literature 1: Japanese Laid-Open Patent Application No. JP-2022-024741

### SUMMARY

According to the technique disclosed in Patent Literature 1, presence or absence of an abnormality is determined by continuously monitoring the stability of the result of recognition by the periphery monitoring sensor. However, when an object supposed to be recognized is not actually recognized, it is not possible to determine the presence or absence of abnormality. In addition, in a case where erroneous recognition (erroneous detection) of an object continues, the presence or absence of abnormality cannot be determined. That is, accuracy of the abnormality detection depends on recognition performance of the recognition system including the periphery monitoring sensor.

An object of the present disclosure is to provide a technique capable of appropriately detecting an abnormality of an autonomous driving system of a vehicle.

A first aspect relates to an abnormality detection system applied to an autonomous driving system of a target vehicle.

The abnormality detection system includes one or more processors and one or more storage devices.

The one or more storage devices store travel plan information and reference travel information.

The travel plan information indicates a travel plan of the target vehicle in a first section generated by the autonomous driving system.

The reference travel information indicates a travel record of a reference vehicle different from the target vehicle in the first section.

The one or more processors calculate a deviation between the travel plan of the target vehicle and the travel record of the reference vehicle for each determination position in the first section based on the travel plan information and the reference travel information.

The one or more processors extract the determination position at which the deviation exceeds a threshold as an abnormal position related to an abnormality of the autonomous driving system.

A second aspect relates to an abnormality detection method applied to an autonomous driving system of a target vehicle.

The abnormality detection method is executed by a computer.

The abnormality detection method includes:
acquiring travel plan information indicating a travel plan of a target vehicle in a first section generated by an autonomous driving system;
acquiring reference travel information indicating a travel record of a reference vehicle different from a target vehicle in the first section;
calculating a deviation between the travel plan of the target vehicle and the travel record of the reference vehicle for each determination position in the first section based on the travel plan information and the reference travel information; and
extracting a determination position at which the deviation exceeds a threshold as an abnormal position related to an abnormality of the autonomous driving system.

According to the present disclosure, the travel plan information indicating the travel plan of the target vehicle is compared with the reference travel information indicating the travel record of the reference vehicle. Then, a position at which a deviation between the travel plan of the target vehicle and the travel record of the reference vehicle exceeds a threshold is extracted as an abnormal position related to an abnormality of the autonomous driving system. This method does not depend on recognition performance of the autonomous driving system, since it uses the travel record of the reference vehicle as reference information. That is, it is possible to appropriately detect the abnormality of the autonomous driving system independently of the recognition performance of the autonomous driving system.

### BRIEF DESCRIPTION OF DRAWINGS

FIG. 1 is a block diagram illustrating a configuration example of an autonomous driving system according to an embodiment;

FIG. 2 is a block diagram showing an example of driving environment information according to the embodiment;

FIG. 3 is a conceptual diagram for explaining an example of an abnormality related to autonomous driving control;

FIG. 4 is a conceptual diagram for explaining an example of an abnormality related to autonomous driving control;

FIG. 5 is a conceptual diagram for explaining an overview of an abnormality detection system according to the embodiment;

FIG. 6 is a conceptual diagram for explaining processing by the abnormality detection system according to the embodiment;

FIG. 7 is a block diagram illustrating a configuration example of the abnormality detection system according to the embodiment;

FIG. 8 is a flowchart summarizing processing performed by the abnormality detection system according to the embodiment;

FIG. 9 is a conceptual diagram for explaining a first application example of the abnormality detection system according to the embodiment; and

FIG. 10 is a conceptual diagram for explaining a second application example of the abnormality detection system according to the embodiment.

### DETAILED DESCRIPTION

Embodiments of the present disclosure will be described with reference to the accompanying drawings.

### 1. AUTONOMOUS DRIVING SYSTEM

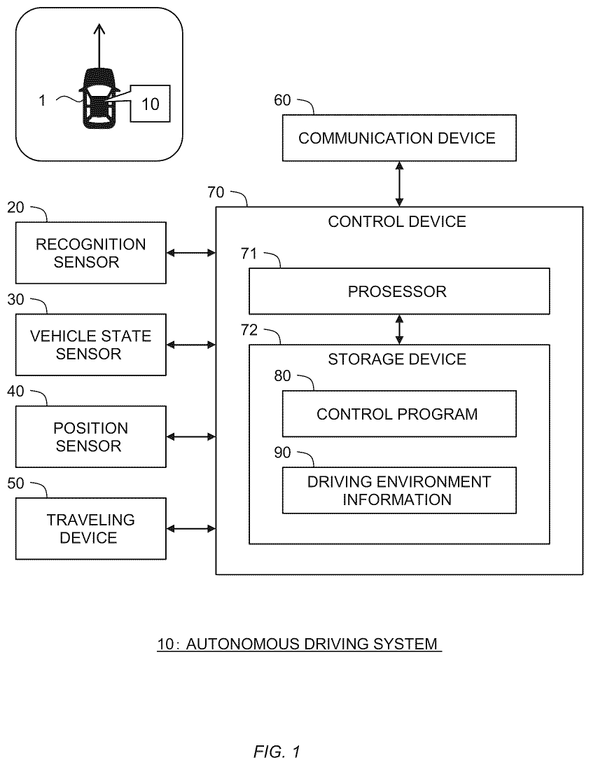

FIG. 1 is a conceptual diagram for explaining an outline of an autonomous driving system 10 according to the present embodiment. The autonomous driving system 10 controls autonomous driving of a vehicle 1. Typically, the autonomous driving system 10 is mounted on the vehicle 1.

The autonomous driving system 10 includes a recognition sensor 20, a vehicle state sensor 30, a position sensor 40, a traveling device 50, a communication device 60, and a control device 70. At least the recognition sensor 20, the vehicle state sensor 30, the position sensor 40, the traveling device 50, and the communication device 60 are mounted on the vehicle 1.

The recognition sensor 20 recognizes (detects) a situation around the vehicle 1. Examples of the recognition sensor 20 include a camera, a laser imaging detection and ranging (LIDAR), a radar, etc. The vehicle state sensor 30 detects a state of the vehicle 1. For example, the vehicle state sensor 30 includes a speed sensor, an acceleration sensor, a yaw rate sensor, a steering angle sensor, etc. The position sensor 40 detects a position and a direction of the vehicle 1. For example, the position sensor 40 includes a global navigation satellite system (GNSS).

The traveling device 50 includes a steering device, a driving device, and a braking device. The steering device steers wheels. For example, the steering device includes an electric power steering (EPS) device. The driving device is a power source that generates a driving force. Examples of the driving device include an engine, an electric motor, and an in-wheel motor. The braking device generates a braking force.

The communication device 60 communicates with the outside via a communication network. Examples of the communication method include mobile communication such as 5G and wireless LAN.

The control device 70 is a computer that controls the vehicle 1. Typically, the control device 70 is mounted on vehicle 1. However, a part of the control device 70 may be disposed in an external device to remotely control the vehicle 1. The control device 70 includes one or more processors 71 (hereinafter, simply referred to as a processor 71) and one or more storage devices 72 (hereinafter, simply referred to as a storage device 72). The processor 71 executes a variety of processing. For example, the processor 71 includes a central processing unit (CPU). The storage device 72 stores a variety of information. Examples of the storage device 72 include a volatile memory, a nonvolatile memory, a hard disk drive (HDD), a solid-state drive (SSD), etc.

A control program 80 is a computer program for controlling the vehicle 1. The processor 71 that executes the control program 80 and the storage device 72 cooperate with each other to realize the functions of the control device 70. The control program 80 is stored in the storage device 72. Alternatively, the control program 80 may be recorded on a non-transitory computer-readable recording medium.

The control device 70 acquires driving environment information 90 indicating a driving environment for the vehicle 1. The driving environment information 90 is stored in the storage device 72.

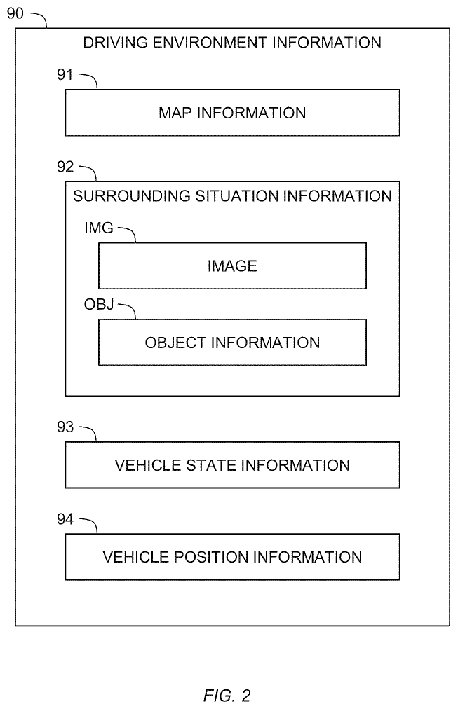

FIG. 2 is a block diagram illustrating an example of the driving environment information 90. The driving environment information 90 includes map information 91, surrounding situation information 92, vehicle state information 93, and vehicle position information 94.

The map information 91 includes a general navigation map. The map information 91 may indicate a lane configuration or a road shape. The map information 91 may include position information of structures, traffic signals, signs, etc. The control device 70 acquires the map information 91 of a necessary area from a map database. The map database may be stored in the storage device 72 or may be stored in a map management device outside of the vehicle 1. In the latter case, the control device 70 communicates with the map management device via the communication device 60 and acquires the necessary map information 91.

The surrounding situation information 92 is information obtained based on a result of recognition by the recognition sensor 20 and indicates a situation around the vehicle 1. The control device 70 recognizes the situation around the vehicle 1 using the recognition sensor 20 and acquires the surrounding situation information 92. For example, the surrounding situation information 92 includes an image IMG captured by the camera. As another example, the surrounding situation information 92 includes point group information obtained by the LIDAR.

The surrounding situation information 92 further includes object information OBJ regarding an object (target) around the vehicle 1. Examples of the object include a pedestrian, a bicycle, a motorcycle, another vehicle (a preceding vehicle, a parked vehicle, etc.), a white line, a traffic signal, a structure (for example, a utility pole, a pedestrian overpass), a sign, an obstacle, etc. The object information OBJ indicates a relative position and a relative speed of the object with respect to the vehicle 1. For example, analyzing the image IMG captured by the camera makes it possible to identify an object and to calculate a relative position of the object. It is also possible to identify an object and acquire a relative position and a relative speed of the object based on the point group information obtained by the LIDAR. The control device 70 may track the recognized object. In this case, the object information OBJ includes trajectory information of the recognized object.

The vehicle state information 93 is information detected by the vehicle state sensor 30 and indicates the state of the vehicle 1. The state of the vehicle 1 includes a vehicle speed, an acceleration, a yaw rate, a steering angle, etc. The control device 70 acquires the vehicle state information 93 from the vehicle state sensor 30. The vehicle state information 93 may indicate a driving state (autonomous driving/manual driving) of the vehicle 1.

The vehicle position information 94 is information indicating a current position of the vehicle 1. The control device 70 acquires the vehicle position information 94 from the result of detection by the position sensor 40. The control device 70 may acquire highly accurate vehicle position information 94 by a known self-position estimation process (localization) using the object information OBJ and the map information 91.

Furthermore, the control device 70 executes vehicle travel control for controlling travel of the vehicle 1. The vehicle travel control includes steering control, acceleration control, and deceleration control. The control device 70 executes the vehicle travel control by controlling the traveling device 50 (i.e., the steering device, the driving device, and the braking device).

In addition, the control device 70 performs autonomous driving control for controlling autonomous driving of the vehicle 1. Here, the autonomous driving means that at least a part of steering, acceleration, and deceleration of the vehicle 1 is automatically performed independently of an operation of a driver. As an example, autonomous driving of level 3 or higher may be performed. The control device 70 generates a travel plan of the vehicle 1 based on the driving environment information 90. Examples of the travel plan include keeping a current travel lane, making a lane change, turning right or left, and avoiding a collision with an object. More specifically, the travel plan includes a route plan and a speed plan of the vehicle 1. The route plan is a set of target positions of the vehicle 1. The speed plan is a set of target speeds at respective target positions. A combination of the route plan and the speed plan is also referred to as a “target trajectory”. That is, the target trajectory includes the target position and the target speed of the vehicle 1. The control device 70 performs the vehicle travel control such that the vehicle 1 follows the target trajectory.

### 2. ABNORMALITY RELATED TO AUTONOMOUS DRIVING CONTROL

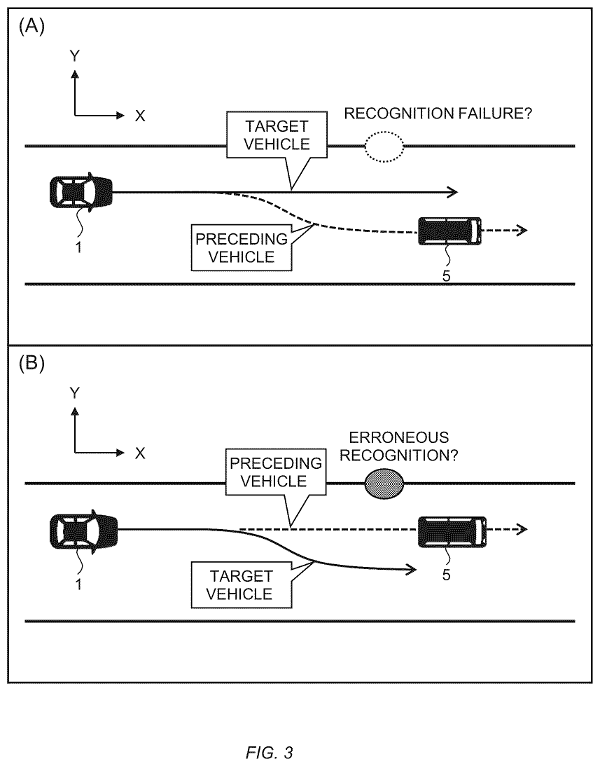

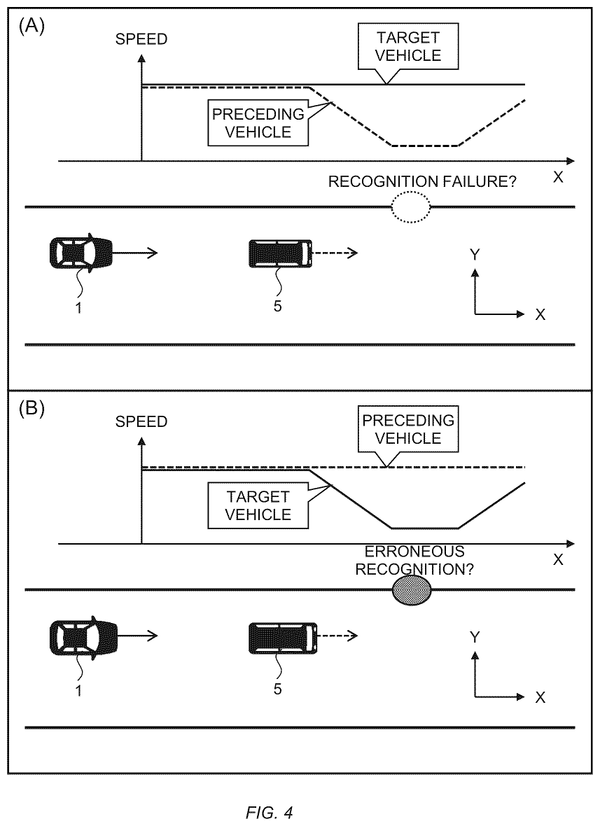

FIGS. 3 and 4 are conceptual diagrams for explaining various examples of an abnormality related to the autonomous driving control. An X-direction is a forward direction of the vehicle 1 or an extending direction of a road. A Y-direction is a lateral direction orthogonal to the X-direction. For convenience, the vehicle 1 that is a target of the autonomous driving control by the autonomous driving system 10 is hereinafter referred to as a “target vehicle 1”. A preceding vehicle 5 is present ahead of the target vehicle 1.

In the example shown in FIG. 3, there is a significant deviation between the route plan of the target vehicle 1 and a movement trajectory of the preceding vehicle 5. Specifically, in the example shown in a part (A) of FIG. 3, the preceding vehicle 5 performs steering as if to avoid something. On the other hand, the travel plan of the target vehicle 1 does not include steering in the vicinity of the position at which the preceding vehicle 5 has performed steering. In this case, the autonomous driving system 10 may not recognize an object supposed to be recognized. That is, recognition failure (detection failure) of an object may have occurred.

In the example illustrated in a part (B) of FIG. 3, the travel plan of the target vehicle 1 includes steering in a direction away from an object. However, the preceding vehicle 5 is traveling straight without steering. In this case, the autonomous driving system 10 may erroneously recognize (erroneously detect) the object.

In the example shown in FIG. 4, there is a significant deviation between the speed plan of the target vehicle 1 and a speed profile of the preceding vehicle 5. Specifically, in the example shown in a part (A) of FIG. 4, the preceding vehicle 5 decelerates for some reason. On the other hand, the travel plan of the target vehicle 1 does not include deceleration in the vicinity of the position where the preceding vehicle 5 decelerates. In this case, the autonomous driving system 10 may not recognize an object supposed to be recognized. That is, recognition failure (detection failure) of an object may have occurred.

In the example illustrated in a part (B) of FIG. 4, the travel plan of the target vehicle 1 includes deceleration for reducing a risk of collision with an object. However, the preceding vehicle 5 does not decelerate at all. In this case, the autonomous driving system 10 may erroneously recognize (erroneously detect) the object.

As described above, when there is a significant deviation between the travel plan of the target vehicle 1 and a travel record of the preceding vehicle 5, the deviation may be caused by an abnormality of the autonomous driving system 10. Conversely, if such the deviation can be found, it is considered possible to detect the abnormality of the autonomous driving system 10. Since this method uses the travel record of the preceding vehicle 5 as reference information, it does not depend on the recognition performance of the autonomous driving system 10. That is, it is possible to appropriately detect the abnormality of the autonomous driving system 10 independently of the recognition performance of the autonomous driving system 10.

Hereinafter, an “abnormality detection system” that is based on the above-described viewpoint will be described in more detail.

### 3. ABNORMALITY DETECTION SYSTEM

### 3-1. Overview

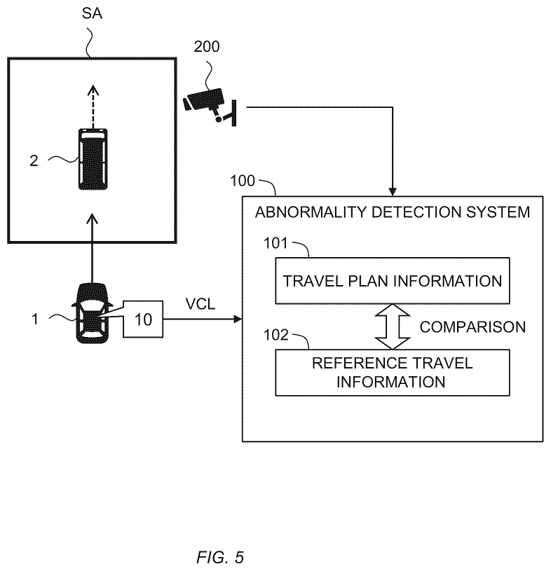

FIG. 5 is a conceptual diagram for explaining an overview of the abnormality detection system 100 according to the present embodiment. The abnormality detection system 100 is applied to the autonomous driving system 10 of the target vehicle 1 and detects an abnormality of the autonomous driving system 10.

The abnormality detection system 100 may be mounted on the target vehicle 1 or may be included in a management device (management server) outside of the target vehicle 1. In any case, the abnormality detection system 100 is configured to communicate with the autonomous driving system 10 of the target vehicle 1 and to acquire necessary information from the autonomous driving system 10. The abnormality detection system 100 may be a part of the autonomous driving system 10 of the target vehicle 1.

The abnormality detection system 100 acquires vehicle information VCL from the autonomous driving system 10 of the target vehicle 1. The vehicle information VCL includes at least the travel plan of the target vehicle 1 generated by the autonomous driving system 10. In particular, the vehicle information VCL includes the travel plan of the target vehicle 1 in a “first section SA” in front of the target vehicle 1. The first section SA is, for example, a section of a predetermined distance along a road on which the target vehicle 1 travels. The travel plan of the target vehicle 1 includes the route plan and the speed plan of the target vehicle 1. i.e., the target trajectory of the target vehicle 1.

Travel plan information 101 is information indicating the travel plan of the target vehicle 1 in the first section SA. The abnormality detection system 100 acquires the travel plan information 101 based on the vehicle information VCL obtained from the autonomous driving system 10 of the target vehicle 1.

Reference travel information 102 is information indicating a travel record of a reference vehicle 2 in the same first section SA. The reference vehicle 2, which is a vehicle different from the target vehicle 1, travels in the first section SA similarly to the target vehicle 1. For example, the reference vehicle 2 is the preceding vehicle 5 (see FIGS. 3 and 4) that travels in the first section SA ahead of the target vehicle 1. The preceding vehicle 5 here is not limited to a preceding vehicle traveling immediately ahead of the target vehicle 1. The preceding vehicle 5 may have passed through the first section SA within a certain period before a timing at which the target vehicle 1 passes through the first section SA. As another example, the reference vehicle 2 may be a following vehicle that travels in the first section SA after the target vehicle 1.

The travel record of the reference vehicle 2 includes a route record and a speed record of the reference vehicle 2. The route record of the reference vehicle 2 is a set of positions of the reference vehicle 2. The speed record of the reference vehicle 2 is a set of speeds at respective positions of the reference vehicle 2. The speed record may further include acceleration and jerk. As a method of acquiring such the reference travel information 102, various examples are conceivable.

For example, the vehicle information VCL obtained from the autonomous driving system 10 of the target vehicle 1 further includes the object information OBJ, the vehicle state information 93, and the vehicle position information 94. As described above, the object information OBJ includes information on the relative position and the relative speed of a surrounding vehicle (for example, the preceding vehicle 5 or the following vehicle) recognized by the recognition sensor 20. The object information OBJ may include trajectory information of the surrounding vehicle recognized by the recognition sensor 20. The vehicle position information 94 and the vehicle state information 93 indicate an absolute position and an absolute speed of the target vehicle 1, respectively. Based on the information, the abnormality detection system 100 can acquire information on an absolute position and an absolute speed of the surrounding vehicle around the target vehicle 1. That is, the abnormality detection system 100 can acquire the reference travel information 102 indicating the travel record of the reference vehicle 2 (the surrounding vehicle) around the target vehicle 1.

As another example, an infrastructure sensor 200 installed in the first section SA may be used. For example, the infrastructure sensor 200 includes an infrastructure camera. The infrastructure sensor 200 may include a LIDAR. The reference vehicle 2 traveling in the first section SA is recognized (detected) by the infrastructure sensor 200. The abnormality detection system 100 communicates with the infrastructure sensor 200 and acquires information related to a result of recognition by the infrastructure sensor 200. The position (trajectory) of the reference vehicle 2 is calculated based on the result of recognition by the infrastructure sensor 200. The speed of the reference vehicle 2 means a temporal change in the position of the reference vehicle 2. Therefore, the abnormality detection system 100 can acquire the reference travel information 102 indicating the travel record of the reference vehicle 2 traveling in the first section SA.

As yet another example, a recognition sensor mounted on a third vehicle that is neither the target vehicle 1 nor the reference vehicle 2 may be used. The reference vehicle 2 traveling in the first section SA is recognized by the recognition sensor mounted on the third vehicle. The abnormality detection system 100 communicates with the third vehicle and acquires information related to a result of recognition by the recognition sensor. The abnormality detection system 100 can acquire the reference travel information 102 indicating the travel record of the reference vehicle 2 traveling in the first section SA based on the information.

As described above, the abnormality detection system 100 acquires the travel plan information 101 indicating the travel plan of the target vehicle 1 and the reference travel information 102 indicating the travel record of the reference vehicle 2. The abnormality detection system 100 compares the travel plan of the target vehicle 1 with the travel record of the reference vehicle 2 in the first section SA based on the travel plan information 101 and the reference travel information 102. More specifically, the abnormality detection system 100 compares the travel plan of the target vehicle 1 with the travel record of the reference vehicle 2 for each determination position in the first section SA.

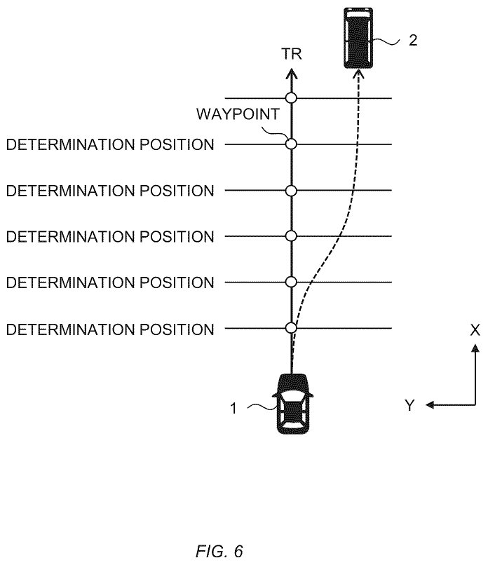

FIG. 6 is a conceptual diagram for explaining the determination position. For example, a plurality of determination positions are discretely set in the first section SA in front of the vehicle 1. The plurality of determination positions are apart from each other in the X-direction. For example, position of waypoints on the target trajectory TR of the target vehicle 1 may be used as the determination positions.

The abnormality detection system 100 compares the travel plan of the target vehicle 1 with the travel record of the reference vehicle 2 for each determination position in the first section SA. Based on this comparison, the abnormality detection system 100 calculates a deviation between the travel plan of the target vehicle 1 and the travel record of the reference vehicle 2 for each determination position in the first section SA. Then, the abnormality detection system 100 extracts a determination position at which the deviation exceeds a threshold as an abnormal position related to the abnormality of the autonomous driving system 10. The other determination positions are determined as normal positions.

For example, the abnormality detection system 100 compares the route plan of the target vehicle 1 with the route record of the reference vehicle 2 for each determination position in the first section SA. In other words, the abnormality detection system 100 compares the Y-direction target position of the target vehicle 1 with the Y-direction position of the reference vehicle 2 for each determination position. Based on this comparison, the abnormality detection system 100 calculates a positional deviation (Y-direction distance) between the route plan of the target vehicle 1 and the route record of the reference vehicle 2 for each determination position. Then, the abnormality detection system 100 extracts the determination position at which the positional deviation exceeds a first threshold as the abnormal position related to the abnormality of the autonomous driving system 10.

For another example, the abnormality detection system 100 compares the speed plan of the target vehicle 1 with the speed record of the reference vehicle 2 for each determination position in the first section SA. Based on this comparison, the abnormality detection system 100 calculates a speed deviation between the speed plan of the target vehicle 1 and the speed record of the reference vehicle 2 for each determination position. Then, the abnormality detection system 100 extracts the determination position at which the speed deviation exceeds a second threshold as the abnormal position related to the abnormality of the autonomous driving system 10.

The extraction of the abnormal position means that there is an abnormality in the autonomous driving system 10 of the target vehicle 1. In this way, the abnormality detection system 100 can detect the abnormality of the autonomous driving system 10 of the target vehicle 1.

It should be noted that the abnormality detection processing by the abnormality detection system 100 may be performed in real time or offline. For example, the abnormality detection system 100 may acquire the vehicle information VCL from the autonomous driving system 10 in real time and determine the presence or absence of the abnormality in the autonomous driving system 10 in real time. As another example, the abnormality detection system 100 may temporarily store the vehicle information VCL acquired from the autonomous driving system 10 and verify the presence or absence of the abnormality in the autonomous driving system 10 at an arbitrary timing.

### 3-2. Configuration Example

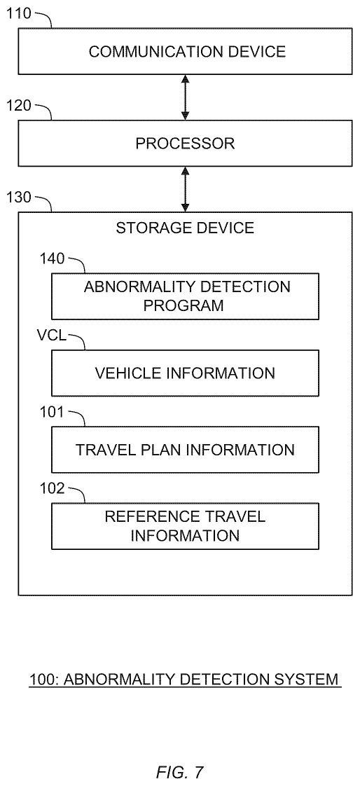

FIG. 7 is a block diagram illustrating a configuration example of the abnormality detection system 100. The abnormality detection system 100 includes a communication device 110, one or more processors 120 (hereinafter simply referred to as a processor 120), and one or more storage devices 130 (hereinafter simply referred to as a storage device 130).

The communication device 110 communicates with the target vehicle 1 (the autonomous driving system 10), the infrastructure sensor 200, the third vehicle, etc. Examples of the communication method include mobile communication such as 5G and wireless LAN.

The processor 120 executes a variety of processing. For example, the processor 120 includes a CPU. The storage device 130 stores a variety of information. Examples of the storage device 130 include a volatile memory, a nonvolatile memory, an HDD, an SSD, etc.

An abnormality detection program 140 is a computer program executed by the processor 120. The processor 120 that executes the abnormality detection program 140 and the storage device 130 cooperate with each other to realize the functions of the abnormality detection system 100. The abnormality detection program 140 is stored in the storage device 130. Alternatively, the abnormality detection program 140 may be recorded on a non-transitory computer-readable recording medium.

The processor 120 acquires the vehicle information VCL from the autonomous driving system 10 of the target vehicle 1 via the communication device 110. The processor 120 may acquire information related to the result of recognition from the infrastructure sensor 200 via the communication device 110. The processor 120 may acquire information about the result of recognition from the third vehicle via the communication device 110. The processor 120 stores the acquired information in the storage device 130. Furthermore, the processor 120 acquires the travel plan information 101 and the reference travel information 102 based on the acquired information. The processor 120 stores the travel plan information 101 and the reference travel information 102 in the storage device 130. Then, the processor 120 executes the above-described abnormality detection process based on the travel plan information 101 and the reference travel information 102.

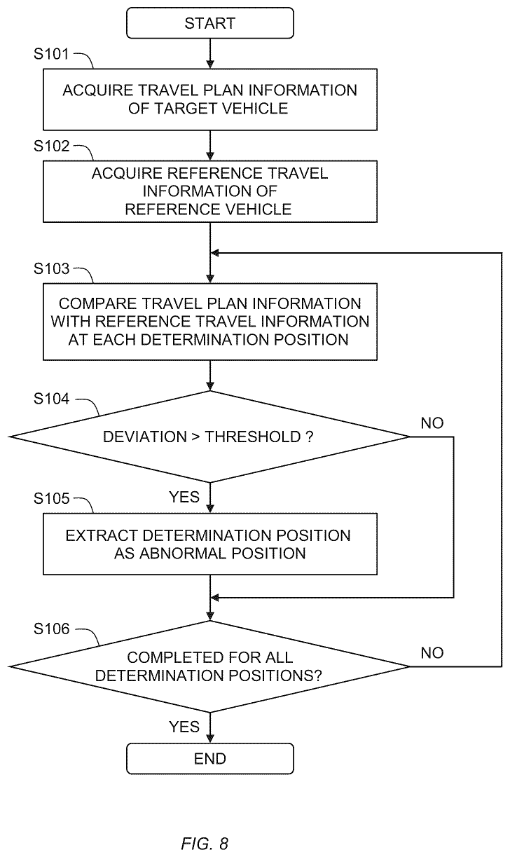

FIG. 8 is a flowchart summarizing the abnormality detection process.

In Step S101, the processor 120 acquires the travel plan information 101 indicating the travel plan of the target vehicle 1 in the first section SA.

In Step S102, the processor 120 acquires the reference travel information 102 indicating the travel record of the reference vehicle 2 in the first section SA.

In Step S103, the processor 120 compares the travel plan information 101 with the reference travel information 102. Based on the comparison, the processor 120 calculates a deviation between the travel plan of the target vehicle 1 and the travel record of the reference vehicle 2. The deviation is calculated for each determination position in the first section SA. Thereafter, the process proceeds to Step S104.

In Step S104, the processor 120 determines whether or not the deviation exceeds a threshold. When the deviation exceeds the threshold (Step S104; Yes), the process proceeds to Step S105. On the other hand, when the deviation is equal to or less than the threshold (Step S104; No), the process proceeds to Step S106.

In Step S105, the processor 120 extracts the current determination position as the abnormal position related to the abnormality of the autonomous driving system 10. Thereafter, the process proceeds to Step S106.

In Step S106, the processor 120 determines whether the next determination position remains in the first section SA. When the next determination position remains (Step S106; No), the processing returns to Step S103, and the next determination position is selected. When the determination process is completed for all the determination positions (Step S106; Yes), the process ends.

### 3-3. Effect

As described above, according to the present embodiment, the travel plan information 101 indicating the travel plan of the target vehicle 1 is compared with the reference travel information 102 indicating the travel record of the reference vehicle 2. Then, a position at which a deviation between the travel plan of the target vehicle 1 and the travel record of the reference vehicle 2 exceeds a threshold is extracted as an abnormal position related to an abnormality of the autonomous driving system 10. Since this method uses the travel record of the reference vehicle 2 as the reference information, it does not depend on the recognition performance of the autonomous driving system 10. That is, it is possible to appropriately detect the abnormality of the autonomous driving system 10 without depending on the recognition performance of the autonomous driving system 10.

### 4. APPLICATION EXAMPLE

### 4-1. First Application Example

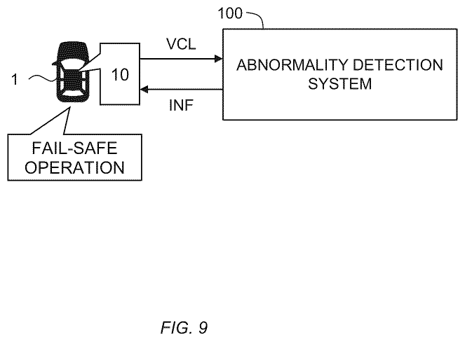

FIG. 9 is a conceptual diagram for explaining a first application example of the abnormality detection system 100. In the example illustrated in FIG. 9, the abnormality detection system 100 acquires the vehicle information VCL from the autonomous driving system 10 in real time. The vehicle information VCL includes at least the travel plan of the target vehicle 1. Then, the abnormality detection system 100 determines the presence or absence of an abnormality in the autonomous driving system 10 in real time.

A case where an abnormal position is extracted in the first section SA is considered. The extraction of the abnormal position means that an abnormality of the autonomous driving system 10 of the target vehicle 1 is detected. In this case, the abnormality detection system 100 feeds back the detection of the abnormality to the autonomous driving system 10 in real time. More specifically, the abnormality detection system 100 transmits notification information INF indicating that an abnormality has been detected to the autonomous driving system 10. The autonomous driving system 10 receiving the notification information INF executes, for example, a fail-safe operation. For example, the fail-safe operation includes safely decelerating and stopping the target vehicle 1. As another example, the fail-safe operation may include causing the target vehicle 1 to perform evacuation traveling to a predetermined safe position such as a road shoulder.

The abnormality detection system 100 may explicitly instruct the autonomous driving system 10 to perform the fail-safe operation. More specifically, the abnormality detection system 100 transmits notification information INF instructing execution of the fail-safe operation to the autonomous driving system 10. In response to the notification information INF, the autonomous driving system 10 executes the fail-safe operation.

As described above, by executing the fail-safe operation in response to the abnormality detection, the safety of the target vehicle 1 is ensured.

### 4-2. Second Example

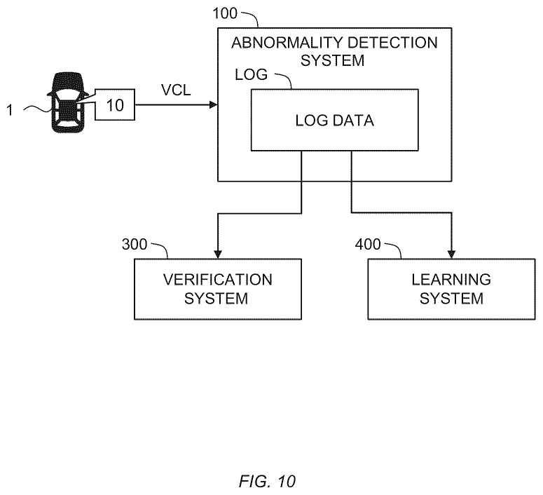

FIG. 10 is a conceptual diagram for explaining a second application example of the abnormality detection system 100. As described above, the autonomous driving system 10 executes the autonomous driving control based on the sensor detection information detected by the various sensors (20, 30, 40) mounted on the target vehicle 1. The vehicle information VCL acquired by the abnormality detection system 100 from the autonomous driving system 10 includes not only the travel plan of the target vehicle 1 but also log data LOG related to the autonomous driving control.

For example, the log data LOG includes the sensor detection information (example: the image IMG, the object information OBJ, the vehicle state information 93, and the vehicle position information 94) used for the autonomous driving control. As another example, the log data LOG may include a control amount of the target vehicle 1 determined by the autonomous driving system 10. As yet another example, the log data LOG may include intermediate data when the control amount of the target vehicle 1 is calculated from the sensor detection information.

A case where an abnormal position is extracted in the first section SA is considered. The extraction of the abnormal position means that an abnormality of the autonomous driving system 10 of the target vehicle 1 is detected. In this case, the abnormality detection system 100 stores the log data LOG obtained in a storage target section in the storage device 130. The storage target section includes at least the extracted abnormal position. For example, the storage target section is a section corresponding to several seconds before and after the abnormal position.

The log data LOG stored in the storage device 130 is used for verification of the autonomous driving system 10, for example. A verification system 300 acquires the log data LOG in the storage target section. Then, the verification system 300 verifies the autonomous driving system 10 in the storage target section based on the log data LOG in the storage target section.

The log data LOG stored in the storage device 130 may be used for training of an autonomous driving AI (machine learning model). A learning system 400 acquires the log data LOG in the storage target section as learning data. When the log data LOG includes the image IMG captured by the camera, an annotation process may be performed on the image IMG. That is, the learning system 400 may acquire the log data LOG in the storage target section as annotation target data. Useful learning data can be obtained by performing annotation on the image IMG around the abnormal position.

What is claimed is:

1. An abnormality detection system applied to an autonomous driving system of a target vehicle, comprising: one or more processors; and
one or more storage devices, wherein
the one or more storage devices are configured to store:
travel plan information indicating a travel plan of the target vehicle in a first section generated by the autonomous driving system; and
reference travel information indicating a travel record of a reference vehicle different from the target vehicle in the first section,
the one or more processors are configured to:
calculate a deviation between the travel plan of the target vehicle and the travel record of the reference vehicle for each determination position in the first section based on the travel plan information and the reference travel information; and extract the determination position at which the deviation exceeds a threshold as an abnormal position related to an abnormality of the autonomous driving system.

2. The abnormality detection system according to claim 1, wherein
the travel plan of the target vehicle in the first section includes a route plan and a speed plan of the target vehicle in the first section, and
the travel record of the reference vehicle in the first section includes a route record and a speed record of the reference vehicle in the first section.

3. The abnormality detection system according to claim 1, wherein
the travel plan of the target vehicle in the first section includes a route plan of the target vehicle in the first section,
the travel record of the reference vehicle in the first section includes a route record of the reference vehicle in the first section, and
the one or more processors are configured to:
calculate a positional deviation between the route plan of the target vehicle and the route record of the reference vehicle for each determination position in the first section based on the travel plan information and the reference travel information; and
extract the determination position at which the positional deviation exceeds a first threshold as the abnormal position.

4. The abnormality detection system according to claim 1, wherein
the travel plan of the target vehicle in the first section includes a speed plan of the target vehicle in the first section,
the travel record of the reference vehicle in the first section includes a speed record of the reference vehicle in the first section, and
the one or more processors are configured to:
calculate a speed deviation between the speed plan of the target vehicle and the speed record of the reference vehicle for each determination position in the first section based on the travel plan information and the reference travel information; and
extract the determination position at which the speed deviation exceeds a second threshold as the abnormal position.

5. The abnormality detection system according to claim 1, wherein
the reference vehicle is a peripheral vehicle recognized by a recognition sensor mounted on the target vehicle, and
the reference travel information is obtained from a result of recognition by the recognition sensor.

6. The abnormality detection system according to claim 5, wherein
the reference vehicle is a preceding vehicle traveling ahead of the target vehicle.

7. The abnormality detection system according to claim 1, wherein
the reference vehicle is a vehicle recognized by an infrastructure sensor, and
the reference travel information is generated based on a result of recognition by the infrastructure sensor.

8. The abnormality detection system according to claim 1, wherein
the one or more processors acquire the travel plan of the target vehicle from the autonomous driving system in real time, and
the one or more processors feedback a notification of abnormality detection to the autonomous driving system when the abnormal position is extracted in the first section.

9. The abnormality detection system according to claim 1, wherein
the one or more processors acquire the travel plan of the target vehicle from the autonomous driving system in real time, and
the one or more processors instruct the autonomous driving system to perform a fail-safe operation when the abnormal position is extracted in the first section.

10. The abnormality detection system according to claim 1, wherein
the autonomous driving system executes autonomous driving control for controlling autonomous driving of the target vehicle based on sensor detection information detected by a sensor mounted on the target vehicle, and
the one or more processors store log data related to the autonomous driving control in a storage target section including the abnormal position in the one or more storage devices.

11. An abnormality detection method applied to an autonomous driving system of a target vehicle and executed by a computer,
the abnormality detection method comprising:
acquiring travel plan information indicating a travel plan of the target vehicle in a first section generated by the autonomous driving system;
acquiring reference travel information indicating a travel record of a reference vehicle different from the target vehicle in the first section;
calculating a deviation between the travel plan of the target vehicle and the travel record of the reference vehicle for each determination position in the first section based on the travel plan information and the reference travel information; and
extracting the determination position at which the deviation exceeds a threshold as an abnormal position related to an abnormality of the autonomous driving system.
